(19) United States
(12) Patent Application Publication
(10) Pub. No.: US 2026/0249801 A1
(43) Pub. Date: Aug. 27, 2026

(54) METHOD FOR OPERATING AN OCCUPANT PROTECTION SYSTEM FOR A MOTOR VEHICLE

(71) Applicant: Continental Automotive Technologies GmbH, Hannover (DE)

(72) Inventors: Boris Steeger, Alzenau (DE); Alexander Sauermann, Alzenau (DE); Andreas Forster, Wörth (DE); Udo Geißler, Blankenbach (DE)

(73) Assignee: Continental Automotive Technologies GmbH, Hannover (DE)

(21) Appl. No.: 18/877,352

(22) PCT Filed: Jun. 21, 2023
(86) PCT No.: PCT/DE2023/200121

§ 371 Date: Dec. 20, 2024

(30) Foreign Application Priority Data
Jul. 8, 2022 (DE) 10 2022 207 011.9

(51) Int. Cl. B60R 21/015; B60R 21/013

(52) U.S. Cl. CPC B60R 21/01512; B60R 21/013

(57) ABSTRACT

A method for operating an occupant protection system for a motor vehicle, in which at least a number of trigger configurations of the occupant protection system are specified in each case for a specified number of different sample occupant situations and for a specified number of sample accident situations, and the influence of at least the possible trigger configurations on the danger situation is evaluated.

### CROSS-REFERENCE TO RELATED APPLICATIONS

The present application is a National Stage Application under 37 C.F.R. § 371 of International Patent Application No. PCT/DE2023/200121 filed on Jun. 21, 2023, and claims priority from German Patent Application No. 102022207011.9 filed in the German Patent and Trade Mark Office on Jul. 8, 2022, the disclosures of which are herein incorporated by reference in their entireties.

### BACKGROUND

### 1. Field

Aspects and objects of embodiments of the present application relate to a method for operating an occupant protection system for a motor vehicle.

### 2. Description of Related Art

Occupant protection systems usually consist of various airbags, seat belt pretensioners, etc. and are nowadays designed and evaluated according to legally specified load cases. The load cases establish, for example, the impact speed, the collision object with which the impact occurs, as well as the position of the occupant in the vehicle. As a general rule, the seat positions which a man of medium height and a small woman would probably take up to drive a motor vehicle are taken into account. These positions are also assumed for occupants in the front passenger seat.

### SUMMARY

In the crash simulation and design of the occupant protection system and vehicle, the evaluation is done by comparing the stress values measured in various body regions such as, e.g., accelerations, forces, changes in position or indentations, etc. with legal limits. The occupant stress is substantially only evaluated using a few (1 to <10) sample or test configurations.

The evaluation is done based on individual stress values in the various body regions. It becomes more difficult to compare various restraint systems as the number of test configurations increase, since a compromise always has to be found for the likelihood of injury in the individual body regions.

By contrast, only a much smaller number of parameters are detected for the triggering behavior during driving mode of a motor vehicle, and the occupant protection devices are triggered via fixed, pre-calibrated triggering paths, without taking the stress values into account.

By contrast, the object is to evaluate various crash configurations (or seat positions of the occupant), as they can also occur on the front passenger side (e.g., occupants in a lying position or with the seat pushed backwards) during autonomous driving or driving of a vehicle controlled by a driver in relation to the expected severity of injuries more accurately, and to determine and activate the best possible protection concept for each configuration, but to nevertheless keep the computational effort in the control unit within acceptable limits.

Thus, a method for operating an occupant protection system for a motor vehicle is described, in which the occupant protection system makes it possible for at least one control unit as well as various occupant protection devices such as airbags, seat belt pretensioners or other actuators, e.g., at the vehicle seat, to optimize the seat position or position of cushion surfaces in relation to the occupant.

In addition, sensors for identifying the type and severity of an impending or occurring accident are provided, that is to say, for example acceleration sensors, rotational speed sensors or crash contact sensors or preferably also predictive environment sensors such as radar, lidar or camera sensors, ultrasonic sensors or the like for evaluation prior to the actual crash.

In addition, at least one occupant detection means is provided for identifying an occupant situation, for example an interior camera, wherein the position of the occupant in the vehicle and the position of the seat can also be detected via seat mats or other types of sensors.

The control unit triggers the occupant protection system as a function of the signals from all these sensors.

However, whilst the sensor signals were previously fed into a few triggering paths, which were indeed definitely optimized and calibrated in advance based on stress values, the stress values are no longer taken into account, to date, during the actual triggering; the approach in the present method is different.

Thus, through crash tests or, preferably, rather through simulations for a specified number of different sample occupant situations as the first dimension and a specified number of sample accident situations as the second dimension, at least a number of trigger configurations of the occupant protection system are specified in each case as the third dimension, and the influence of at least the possible trigger configurations on the danger situation is evaluated. Due to the number of sample occupant situations times the number of sample accident situations times the number of trigger configurations to be taken into account, the memory requirements naturally increase, but of course so do the quality of the data and, ultimately, the triggering decision.

Moreover, however, a further decisive refinement is made in that for a plurality of body parts of the occupant at least one stress value is determined for each body part in each case, and is standardized with respect to a default value.

Thus, a plurality of different stress values can also be evaluated for each body part, for example acting forces or accelerations and displacements, deformations, resulting therefrom, etc. The standardization with respect to a default value creates a relative variable which, thus standardized across inherently physically different parameters, can be clearly evaluated more easily.

From the standardized stress values or the variable derived therefrom, in addition a maximum value is now formed, on the one hand, and in addition a mean value, on the other hand, for the plurality of body parts.

The maximum value depicts the highest value of a standardized stress value as a measure of the local stress on a part of the body, while, thanks to the averaging, a further, independent decision variable is in addition determined about the total stress.

All of these data are stored in a suitable form, for example tables, in the memory. The effort of the simulation and evaluation is definitely considerable, but it only takes place in the preceding simulation and does not have to be performed continuously during driving mode. Nevertheless, this refined evaluation allows a significantly improved triggering decision. To this end, during driving mode of the motor vehicle, if an impending or occurring accident situation is identified, on the one hand, the current accident situation is compared to the specified number of sample accident situations and at least one best-matching sample accident situation is established. This can be directly precisely one of the specified sample accident situations or an evaluation can be done, for example, by interpolation from a plurality of sample accident situations.

On the other hand, the current occupant situations are compared to the specified number of sample occupant situations and at least one best-matching sample occupant situation is established. Here as well, this can be directly one of the specified sample accident situations or can be done by interpolation from a plurality of sample accident situations.

Then, from the number of trigger configurations of the occupant protection system, the algorithm only has to select that trigger configuration for which first the maximum value is lowest and, if a plurality of trigger configurations remains, in addition the mean value is lowest.

In one exemplary embodiment, the best-matching sample accident situation for the current accident situation can be established from the specified number of sample accident situations in that the relative deviation of the parameters currently detected by the sensors for identifying the type and severity of an impending or occurring accident from, in each case, a default value assigned to the sample accident situation is determined, and that sample accident situation with the smallest deviation in total across all of the parameters is determined.

Similarly, in a preferred embodiment, the best-matching sample occupant situation(s) for the current occupant situation can be established from the specified number of occupant situations in that the relative deviation of currently detected parameters of the at least one occupant detection means from, in each case, a default value assigned to the sample occupant situation is determined, and that sample occupant situation with the smallest deviation in total across all of the parameters is determined.

However, in a further development, it is in addition conceivable that a weighting factor is assigned to at least some parameters or each parameter, wherein a weighting factor deviating from the others is provided for at least one parameter and the total of the thus weighted relative deviation is determined. The unequal relevance of the individual parameters for the triggering is taken into greater account and it can in particular also be provided that some parameters are set to the weight “zero”, that is to say that they are de facto not taken into account for the special set-up.

A further embodiment continues along these lines. For at least one individual occupant protection device or a subgroup of the number of trigger configurations of the occupant protection system, only a subgroup of the number of parameters is to be taken into account in each case. Of course, that is preferably at least the most relevant parameter for the triggering decision, which is then taken into account for exactly this particular occupant protection device or subgroup of the number of trigger configurations of the occupant protection system. That is to say that not all of the parameters have to be taken into account for all occupant protection devices, but rather subgroups are deliberately formed from the number of trigger configurations of the occupant protection system, for which the evaluation is done with a significantly smaller number of parameters with regard to the occupant situation and/or accident situation. However, from the number of trigger configurations of the occupant protection system, that trigger configuration which meets the two-dimensional evaluation both in terms of the maximum value and the mean value is always to be selected.

That is to say that the best-matching sample occupant situations for the current occupant situation and/or the best-matching sample accident situation for the current accident situation is/are only established based on this subgroup of the number of parameters, at least the most relevant parameter for the triggering decision.

In a further embodiment, it is, in addition, provided that a weighting factor is assigned in each case for the plurality of body parts for the standardized stress values or variables derived therefrom, wherein a weighting factor deviating from the others is provided for at least one stress value, and a weighted mean value is thus established. That is to say that not all of the parameters necessarily have the same weight in the averaging, but rather a relevance for the triggering can also be taken into account here.

A further embodiment provides that the standardized stress values are divided into a specified number of danger levels for the plurality of body parts, and the maximum value of the danger levels of the body parts, which was determined during the trigger configuration and the sample occupant situations and the sample accident situations, is used as the maximum value. These danger levels can be easily illustrated, e.g., via a color scheme, where values which are not critical for the occupant can be illustrated, e.g., as green, while more critical values can be illustrated via yellow to orange, and completely dangerous or even deadly values can be illustrated as red or the like, wherein, when implemented in an algorithm, this can also be implemented by simple level values, e.g., from 1 to 5.

The maximum values within a danger level are then preferably not differentiated any further, but rather the mean values have a somewhat greater influence on the triggering decision.

A further preferred embodiment results if, for the current accident situation, instead of the one best-matching sample accident situation, a plurality of the closest sample accident situations and/or for the current occupant situation, instead of the one best-matching sample occupant situation, a plurality of the closest sample occupant situations is/are established and for the current accident situation and/or current occupant situation for at least individual occupant protection devices, at least for the subgroup of the most relevant parameters for the triggering thereof, these parameters are established from the interpolation of the values of the plurality of the closest sample accident situations and/or the plurality of the closest sample occupant situations. Such an interpolation can allow the triggering decision to become even more precise or make it possible to manage with significantly fewer specified sample accident situations or sample occupant situations which do of course, therefore, also have to be saved. The effort of the interpolation also remains manageable if a restriction of only a few parameters is set, and this can, in turn, be easily justified, in particular, if at least individual occupant protection devices are considered to a limited extent and only a manageable number of parameters are taken into account for these and only the most important parameter(s) is/are interpolated as well. That is to say that, for different occupant protection devices, only subgroups of the parameters are therefore always taken into account, but always in addition to the maximum value or danger level derived therefrom and also the mean value.

According to an aspect of an embodiment, there is provided a control unit for an occupant protection system for a motor vehicle, which has at least one input interface for connecting sensors for identifying the type and severity of an impending or occurring accident as well as at least one occupant detection means as well as at least one output interface for connecting occupant protection devices. According to an aspect of an embodiment, an algorithm for performing the method is stored with corresponding standardized stress values for the body parts in the respective specified sample occupant situations and the sample accident situations in the trigger configurations provided in each case for this purpose.

Objects and aspects of the embodiments are described in greater detail below with reference to figures and exemplary embodiments.

### BRIEF DESCRIPTION OF THE DRAWINGS

FIG. 1 is a block diagram of an occupant protection system, according to an embodiment;

FIG. 2 is a diagram illustrating an occupant protection system decision, according to an embodiment;

FIG. 3 is a table illustrating an occupant protection system decision, according to an embodiment; and

FIG. 4 is a matrix of the stress values determined from a simulation of a vehicle for a specific occupant and accident situation, and triggering strategy, according to an embodiment.

### DETAILED DESCRIPTION OF EMBODIMENTS

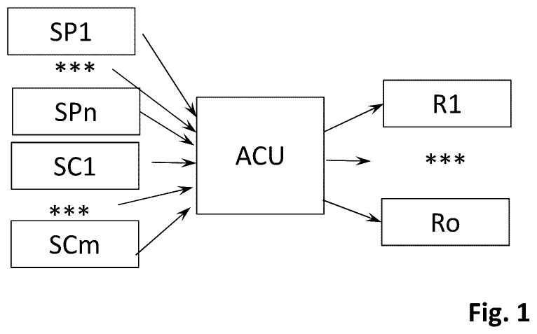

FIG. 1 first outlines the basic hardware structure of an occupant protection system for a motor vehicle. The core point and the definitive, independently tradable unit is a control unit ACU, which has the connections, which are depicted here as arrows, to the input interfaces for connecting sensors for identifying the type and severity of an impending or occurring accident, referred to here as SC1 . . . SCm, as well as the connections, which are depicted as arrows, to the input interfaces for connecting occupant detection means SP1 to SPn. Likewise depicted as arrows are the connections to the output interfaces for connecting occupant protection devices R1 . . . Ro. The control unit or the occupant protection system only differs from a conventional system in the algorithm stored in the memory, in particular the stored sample occupant situations and sample accident situations as well as the standardized stress values determined therefor for the body parts for the respective parameters in the trigger configurations under consideration.

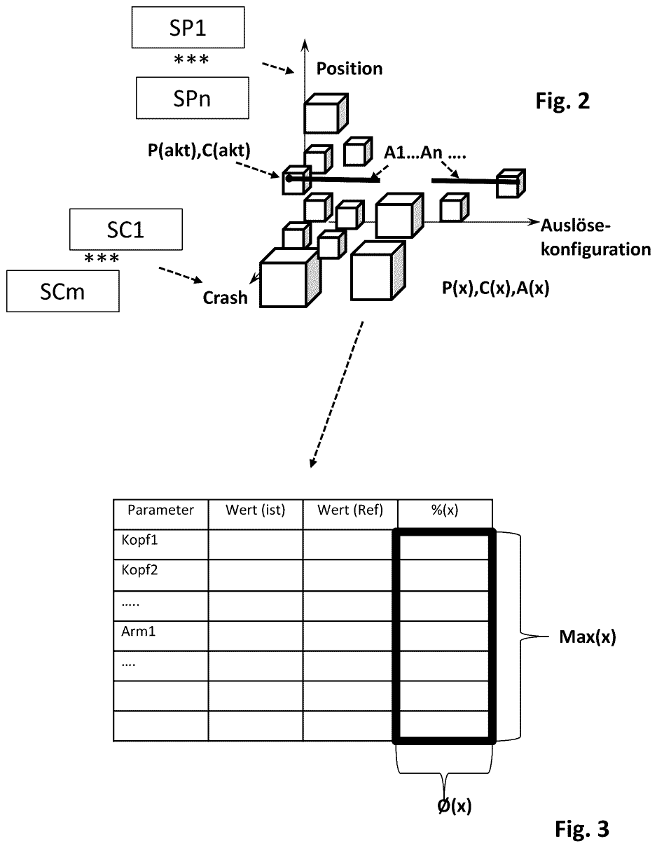

FIG. 2 now outlines these three dimensions of the decision, namely the occupant situation as the “position” axis, the accident situation as the “crash” axis, wherein the impending accident situations are of course also comprised on the basis of the environment detection, that is to say virtually “precrash”, and the third dimension comprises the various trigger configurations.

The signals from the sensors SP1 to SPn for identifying the occupant situation are included in the occupant situation as the “position” axis.

The direct accident sensors such as acceleration and rotational speed sensors as well as the signals from the environment detection such as, for example, camera, radar or lidar and also ultrasonic sensors are included in the accident situation as the “crash” axis.

This initially results in a current occupant situation and accident situation, depicted here as point P(akt), C(akt), for which the various trigger configurations result as the third dimension. As is to be depicted by the thick line A1 . . . An, some trigger configurations are conceivable, but others are not and the line is also interrupted accordingly.

The boxes are now intended to make it clear that only specific, selected sample occupant situations and sample accident situations are stored in each case and the size thereof can vary, that is to say, they can directly cover different sized regions of the occupant situation and accident situation, and the space does not have to be completely filled either, but rather there remain distances, that is to say, free spaces between the individual boxes, for which, indeed, no sample directly covers this, but the best-matching one is then chosen via the rules described, or an interpolation from the neighboring samples is even determined.

It should be made clear once again that in order to minimize the memory requirements and algorithm effort, it is not at all necessary for all theoretically conceivable trigger configurations to be stored for all occupant protection devices, let alone all parameters or standardized stress values again, but rather only the most trigger-relevant parameters have to be stored in each case for individual occupant protection devices or specific subgroups of them, and other parameters or, similarly, from the perspective of the current accident and occupant protection situations, only a significantly smaller number of trigger configurations and parameters are available or come into consideration anyway for other occupant protection devices.

However, each such box theoretically stands for a trigger configuration in the case of a stored sample occupant situation and sample accident situation as well as the standardized stress values stored as parameters therefor.

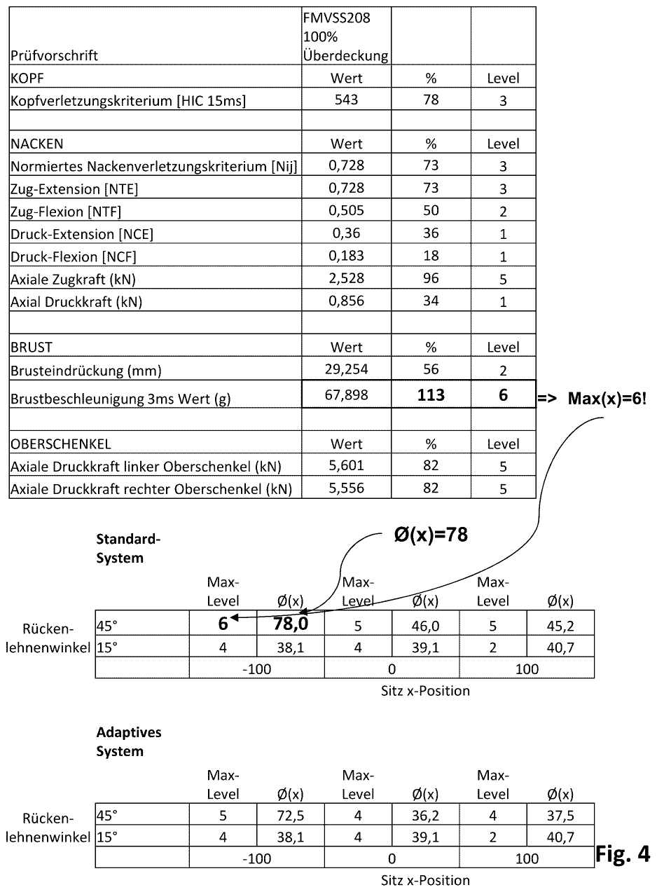

The aim is to make this clear in FIG. 3 based on the table, wherein at least one such worksheet corresponds to virtually every box from FIG. 2.

The stress values (Value(lst)) determined by tests or simulation for this trigger configuration in the defined and stored sample occupant situation and sample accident situation, which are, however, standardized with respect to reference values of the stress value(Ref) to produce a standardized stress value %, are stored there for the most relevant parameters, referred to here abstractly as Head1, Head2 . . . , Arm1, Arm2, etc.

That means that a percentage stress is preferably determined, through which inherently physically absolutely different variables, such as deformations, body displacements or dimensions, etc., are converted to a comparable scale, namely the respective percentage danger to the occupant.

From these different standardized stress values % or from these derived values, two values which are relevant to the decision are now, however, derived, namely on the one hand the value Max(x) as the maximum value of the standardized stress values and also, additionally, the mean value Ø(x). Then, from the number of trigger configurations of the occupant protection system, that trigger configuration is selected for which first the maximum value is lowest and, if a plurality of trigger configurations remains, in addition the mean value is lowest.

The visualization in FIGS. 2 and 3 is purely a rough sketch, and multiple smaller worksheets with only the necessary parameters for this in each case are stored for each box, preferably separated by occupant protection device subgroups. Since different occupant protection device subgroups are completely out of the question for some combinations of occupant situation and accident situation or can in each case cover completely different value ranges, that is to say are of different sizes in the symbol of the boxes, multiple such boxes are provided in order to highlight the necessary values more easily and with less memory effort.

That is to say that the occupant stresses, which are measured in the individual body regions of the occupant (dummies), are combined into a weighted occupant stress index which indicates what percentage of the limits for the individual body regions of the occupant are stressed on average. Individual stress values for individual body regions which are close to or even above the legal limit are preferably taken into account separately in a danger level, for example can be visualized as a color scale (green, yellow, red). This allows the occupant stress for a multiplicity of load cases to be evaluated based on a single numerical value (occupant stress index) and the associated danger level, that is to say the color code in terms of the expected severity of injuries.

With regard to an autonomously driving vehicle in which numerous seat positions are possible, the expected severity of injuries for a specific seat position, which can be determined in simulations or tests, can then be plotted in the form of a matrix which shows the risk of injury to the occupant in various seat positions (with various restraint system configurations).

An interpolation between the individual points of support with suitable functions then provides an indication of the expected risk of injury between the points of support.

Various crash configurations (impact speed, occupant position, occupant size, restraint system configuration (airbags, belts, . . . ) , etc.) can be evaluated based on a stress value and can be easily compared to one another and, indeed, both in terms of the maximum danger at certain points based on the maximum value or derived danger level and, additionally, as a further criterion of the medium average stress.

This offers advantages for all applications in which a multiplicity of configurations has to be considered, e.g., during autonomous driving and, in principle, for all cases in which an evaluation or optimization is to be carried out in a multiplicity of possible configurations with a multiplicity of evaluation criteria.

FIG. 4 now outlines a matrix of the stress values determined from a simulation of a vehicle for a specific occupant and accident situation and of course a defined triggering strategy. There are 6 levels from 1 for absolutely non-critical to level 6 when the limits are significantly exceeded and there is therefore a risk of life-threatening injuries.

It clearly shows the moderate mean value (Ø(x)) across all stress values, which can be assigned to a level 4, but which, due to the one unacceptably high chest stress value (Resultant Acc. 3 ms exceedance (g)) in level 6, leads to the level 6 evaluation of the total situation overall.

This overall evaluation can now be converted into a decision matrix which, in addition to a standard triggering, also shows alternative triggering strategies or adaptations of the parameters such as, e.g., the influence of a changed angle of the backrest.

Even if only by way of example here, danger level 5 can be achieved for an adaptive system and, consequently, this trigger variant is to be chosen.

1. A method of operating an occupant protection system for a motor vehicle, having a control unit, occupant protection devices, and sensors for identifying a type and a severity of an impending or occurring accident, and having at least one occupant detection means for identifying an occupant situation, the method comprising:
determining trigger configurations of the occupant protection system are specified for different occupant situations and accident situations;
determining at least one stress value for each body part standardized with respect to a default value;
forming a maximum value from the standardized stress values or a variable derived therefrom
and
a mean value for the plurality of body parts;
during driving mode of the motor vehicle, if an impending or occurring accident situation is identified,
comparing the current accident situation to the specified number of sample accident situations and establishing at least one best-matching sample accident situation
and, comparing the current occupant situations to the specified number of sample occupant situations and establishing at least one best-matching sample occupant situation;
selecting, from the number of trigger configurations of the occupant protection system, that trigger configuration for which first the maximum value is lowest and, if a plurality of trigger configurations remains, in addition the mean value is lowest.

2. The method according to claim 1, wherein the best-matching sample accident situation for the current accident situation is established from the specified number of sample accident situations, in that the relative deviation of the parameters currently detected by the sensors for identifying the type and severity of an impending or occurring accident from, in each case, a default value assigned to the sample accident situation is determined, and that sample accident situation with the smallest deviation in total across all of the parameters is determined.

3. The method according to claim 1, wherein the best-matching sample occupant situations for the current occupant situations are established from the specified number of occupant situations, in that the relative deviation of currently detected parameters of the at least one occupant detection means from, in each case, a default value assigned to the sample occupant situation is determined, and that sample occupant situation with the smallest deviation in total across all of the parameters is determined.

4. The method according to claim 3, wherein a weighting factor is assigned to each parameter, wherein a weighting factor deviating from the others is provided for at least one parameter and the total of the thus weighted relative deviation is determined.

5. The method according to claim 3, wherein for at least one individual occupant protection device or a subgroup of the number of trigger configurations of the occupant protection system, only a subgroup of the number of parameters, at least the most relevant parameter for the triggering decision, is taken into account in each case, and the best-matching sample occupant situations for the current occupant situations and/or the best-matching sample accident situation for the current accident situation is/are only established based on this subgroup of the number of parameters, at least the most relevant parameter for the triggering decision.

6. The method according to claim 5, wherein a weighting factor is assigned in each case for the plurality of body parts for the standardized stress values or variables derived therefrom, wherein a weighting factor deviating from the others is provided for at least one stress value, and a weighted mean value is thus established.

7. The method according to claim 1, wherein the standardized stress values are divided into a specified number of danger levels for the plurality of body parts, and the maximum value of the danger levels of the body parts, which was determined during the trigger configuration and the sample occupant situations and the sample accident situations, is used as the maximum value.

8. The method according to any one of the preceding claims, wherein for the current accident situation, instead of the one best-matching sample accident situation, a plurality of the closest sample accident situations and/or for the current occupant situation, instead of the one best-matching sample occupant situation, a plurality of the closest sample occupant situations is/are established and for the current accident situation and/or current occupant situation for at least individual occupant protection devices, at least for the subgroup of the most relevant parameters for the triggering thereof, these parameters are established from the interpolation of the values of the plurality of the closest sample accident situations and/or the plurality of the closest sample occupant situations.

9. (canceled)
